(19) United States
(12) Patent Application Publication
(10) Pub. No.: US 2010/0196777 A1
(43) Pub. Date: Aug. 5, 2010

(54) BRACING OF A HIGH TEMPERATURE FUEL CELL STACK

(75) Inventors: Andreas Reinert, Dresden (DE); Christian Klahn, Finstenwalde (DE)

Correspondence Address: FITCH, EVEN, TABIN & FLANNERY, P. O. BOX 18415, WASHINGTON, DC, 20036, US

(73) Assignee: Staxera GmbH, Dresden (DE)

(21) Appl. No.: 12/668,760

(22) PCT Filed: May 13, 2008
(86) PCT No.: PCT/DE2008/000821

§ 371 Date: Jan. 12, 2010

(30) Foreign Application Priority Data
Aug. 3, 2007 (DE) 102007036642.8

(51) Int. Cl. H01M 8/24

(52) U.S. Cl. 429/467

(57) ABSTRACT

The invention relates to a bracing plate for bracing a fuel cell stack. According to the invention it is contemplated that the bracing plate is formed of a plurality of layers, a first layer facing the fuel cell stack and a second layer disposed adjacent to the first layer and arranged on the side opposing the fuel cell stack being provided, the second layer having a higher bending rigidity than the first layer.

The invention relates to a bracing plate for bracing a fuel cell stack.

SOFC fuel cell systems (SOFC=“solid oxide fuel cell”) are composed of a plurality of components including, among others, a reformer, an afterburner as well as a SOFC fuel cell stack. These components are operated at temperatures in the range of 900° C.

As is commonly known, SOFC fuel cell stacks are produced using a defined bracing. Said bracing is ensured by temporary or final bracings during production and storage as well as during the installation in the system. From the DE 103 08 382 B3 and the EP 1 394 880 A1 possibilities for bracing a fuel cell stack are known. A thermally induced change of the length of the stack during a heating process from room temperature to the operating temperature has to be compensated by the bracing.

The components forming the bracing may, in this case, be internal, i.e. exposed to the operating temperature of the SOFC fuel cell stack, like in the EP 1 394 880 A1. The required bracing force may, for example, be generated by gas-filled bellows or expanding elements formed of material combinations with different expansion coefficients.

In this connection it is disadvantageous that expensive materials capable of withstanding the high operating temperature of the SOFC fuel cell have to be used for the bracing of the SOFC fuel cell stack. Further a loss of resiliency may occur in the used high temperature alloys due to creeping processes which may lead to a buckling of the SOFC fuel cell stack.

Alternatively it is also known to arrange the bracing externally, i.e. outside of an insulation surrounding the SOFC fuel cell stack. Such a solution is, for example, known from the DE 103 08 382 B3, the bracing acting on the fuel cell stack via the insulation.

The drawback of this arrangement are problems caused by the retreat of the insulation. In addition it is difficult to reach the fuel cell stack when bracing means acting past the insulation are used to transmit the required bracing forces.

To ensure the coherence of the fuel cell stack and to avoid a buckling of the stack an axial bracing force is required over the entire temperature range between room temperature and the operating temperature.

Therefore the plates at the end of the fuel cell stack are generally formed massively to avoid a buckling of the stack even in case of the reduced strengths of the material caused by the high temperatures.

It is the object of the present invention to provide a generic bracing plate for an SOFC fuel cell stack which at least partly overcomes the disadvantages mentioned above.

Said object is solved by the bracing plate according to claim 1.

Advantageous embodiments and further developments of the invention will also become obvious from the dependent claims.

The bracing plate according to the invention is based on the state of the art in that the bracing plate is constituted of a plurality of layers, in that a first layer facing the fuel cell stack and a second layer disposed adjacent to the first layer and arranged on the side opposing the fuel cell stack are provided and in that the second layer has a higher bending rigidity than the first layer. A multi-layered structure of the bracing plate enables the combination of different materials and material properties in the bracing plate. In this way it becomes possible to design the bracing plate so that it is less heavy, thinner or stiffer at a constant thickness depending on the requirements. The high stiffness of the bracing plate is required to avoid a buckling of the stack caused by different expansion coefficients at room temperature and to ensure the flatness of the base plate and the cover plate at the operating temperature. Thin terminating plates formed of ferritic steels have a tendency to deform due to the intense inclination to creeping.

It may usefully be contemplated that the first and the second layer are fixedly connected to each other. The tight connection between the first and the second layer may, for example, be achieved by a screw connection or by soldering. The tight connection between the first and the second layer facilitates the installation, i.e., in particular, the bracing of the fuel cell stack.

The bracing plate may advantageously be further developed in that the second layer comprises refractory ceramics. Refractory ceramics such as, for example, insulating refractory brick, a refractory ramming mixture, refractory concrete or chamotte have a high bending rigidity even at high temperatures which is why they are well suited for stiffening the bracing plate. Refractory ceramics can be purchased easily and inexpensively in different qualities and forms. Furthermore their bending rigidity even at high temperatures is suitable for suppressing a buckling of the fuel cell stack at the operating temperature. In addition the refractory ceramics act as an electric and first thermal insulating layer of the fuel cell stack.

It may further be contemplated that the first layer comprises a thin sheet metal. The thin sheet metal used will then directly contact the fuel cell stack so that certain limitations relating to the thermal expansion, etc. have to be taken into consideration in the selection of the materials. Usually the thin sheet metal has mechanical properties which are very similar to those of the fuel cell stack. For example, the bracing plate may be used as a terminating cover of the fuel cell stack whereby the gas-tightness of the fuel cell stack may be better ensured in the area of the bracing plate.

Advantageously it may be contemplated that a third layer arranged on the side opposing the fuel cell stack is disposed on the bracing plate.

It may further be contemplated that the third layer comprises a thin sheet metal. Such a third layer comprising a thin sheet metal may serve to uniformly transmit the bracing forces to the fuel cell stack via the second layer. The thin sheet metal may be integrally formed or comprise a plurality of parts, i.e. be a complete sheet or comprise individual large washers formed of metal in the area of the bracing screws. This may also be advantageous with respect to the stability of the refractory ceramics since breaking due to punctually acting bracing forces is avoided.

Conveniently it may be contemplated that the second and the third layer are fixedly connected to each other. The fixed connection between the second and the third layer may, for example, be achieved by a screw connection or by soldering. It facilitates, in particular, the installation of the SOFC fuel cell stack by simplifying the bracing.

It may further be contemplated that means for bracing the fuel cell stack are disposed in the area of the second layer. The means used for bracing the fuel cell stack may, for example, be simple bracing screws preventing a buckling of the fuel cell stack in combination with draw bars and the bracing plate.

Usefully it may be contemplated that the means for bracing comprise at least one laminated ceramic spring and at least one ceramic draw bar. Usually a loss of resiliency of the bracing means occurs due to the use of high temperature resistant alloys when the fuel cell stack is heated. This may result in leakages which may endanger the functionality of the fuel cell stack. For this purpose all the means transmitting bracing forces to the fuel cell stack for bracing the fuel cell stack are made of ceramic materials. In this way a loss of resiliency due to creeping processes in high temperature resistant alloys can be avoided whereby the bracing of the fuel cell stack will be lasting even after repeated temperature changes between room temperature and the operating temperature.

The device for bracing a fuel cell stack according to the invention is based on the state of the art in that the at least one bracing plate is formed of a plurality of layers, in that a first layer facing the fuel cell stack and a second layer disposed adjacent to the first layer and arranged on the side opposing the fuel cell stack are provided and in that the second layer has a higher bending rigidity than the first layer.

Preferred embodiments of the invention will be explained by way of example with reference to the Figures in which:

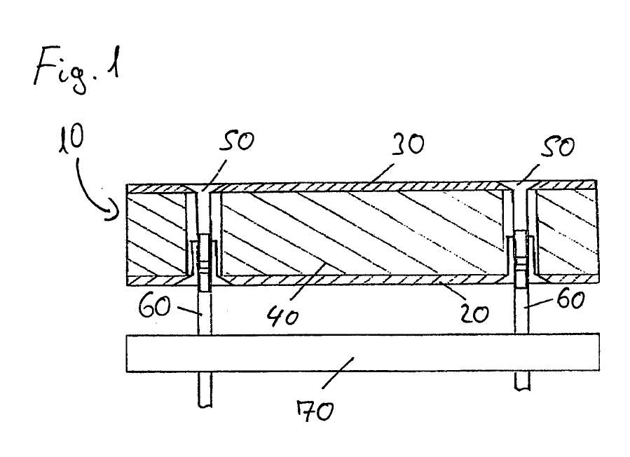

FIG. 1 shows a schematic representation a bracing plate according to the invention;

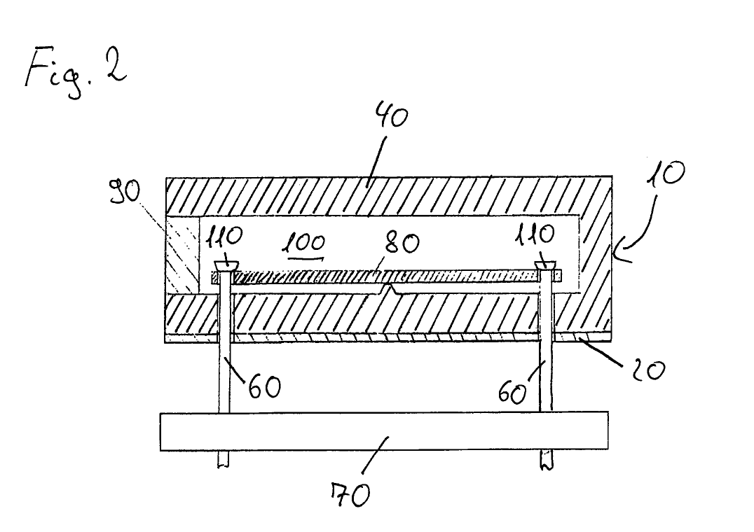

FIG. 2 shows a schematic representation another bracing plate according to the invention; and

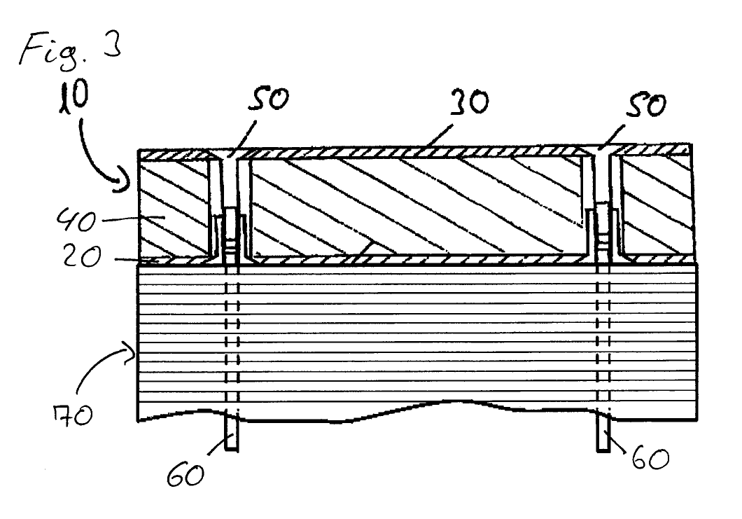

FIG. 3 shows a schematic representation of the bracing plate illustrated in FIG. 1 in the fixedly mounted state.

FIG. 1 shows a schematic representation of a bracing plate 10 according to the invention. The bracing plate 10 comprises a first layer 20, a second layer 40 and a third layer 30. In addition bracing screws 50 are shown which are connected to draw bars 60. According to the illustration the draw bars 60 pass through a fuel cell stack 70. It is also feasible that the draw bars are not passed through the fuel cell itself but the area of the reaction agent supplies and discharges or that the draw bars are lead through an insulation surrounding the stack outside of the actual stack. Usually a possibility to fix the draw bars 60 is provided on the end of the fuel cell stack 70 opposing the illustrated bracing plate 10. For example, another bracing plate 10 may be provided on the other side of the fuel cell stack 70, however, a less intricate construction on the side of the fuel cell stack 70 which is not shown is also feasible since the buckling of the fuel cell stack 70 occurs mainly in one direction. The first layer 20 and the third layer 30 respectively comprise a thin sheet metal while the second layer 40 comprises a refractory ceramic material.

The bracing plate 10 shown in FIG. 1 is not fully mounted on the fuel cell stack 70 which can be recognised due to the gap between the first layer 20 and the fuel cell stack 70. The bracing screws 50 are screwed to the draw bars 30 through the third layer 30 and uniformly transmit the bracing force to the second layer 40, the first layer 20 and the fuel cell stack 70 via the third layer 30 at room temperature.

At room temperature the bracing plate 10 prevents a buckling of the fuel cell stack 70 caused by different expansion coefficients. The bracing of the fuel cell stack 70 illustrated in FIG. 1 is only sufficient at room temperature. Substantially the elastic elements are missing which could compensate the different thermal expansion coefficients of the fuel cell stack 70 and the bracing means when they are heated up. The fuel cell stack 70 can be mounted with the illustrated bracing, however, it should be provided with a final bracing before being activated. Said bracing may optionally be realised in a temperature-resistant form inside of an insulation or in a non-temperature-resistant form outside of the insulation of the fuel cell stack. The bracing force applied to the bracing plate 10 by the final bracing acts on the third layer 30 comprising a sheet metal. In this way the punctually applied bracing force is evenly distributed over the bracing plate 10 whereby a plastic deformation of the fuel cell stack 70 by the bracing force is prevented.

FIG. 2 shows a schematic representation of another bracing plate 10 according to the invention. The bracing plate 10 again comprises a first layer 20 comprising a thin sheet metal and a second layer 40 again comprising a bending-resistant refractory ceramic material such as, for example insulating refractory brick, a refractory ramming mixture, refractory concrete or chamotte. If desired the second layer 40 may be further reinforced by metal fibres or corundum rods or other reinforcing materials. In the area of the second layer 40 further a cavity 100 is provided which is closable by a shutter piece 90. Inside of the cavity 100 a laminated ceramic spring 80 is arranged which is coupled to ceramic draw bars 60 via bracing screws 110 and can thus exert bracing forces to a fuel cell stack 70. By varying the arrangement of the laminated spring 80 or by providing a plurality of laminated springs an adjustment to different geometries of the fuel cell stack may also be achieved. A cavity 100 for accommodating the laminated spring 80 is not stringently required. A corresponding structuring of the ceramic material is sufficient.

The illustrated bracing plate 10 is, analogous to the bracing plate illustrated in FIG. 1, shown in a not yet fully mounted state as can be recognised due to the gap present between the first layer 20 and the fuel cell stack 70. Like in FIG. 1 the opposing side of the fuel cell stack 70 is not shown. However, analogous arguments as the ones brought forth in connection with FIG. 1 apply and at least one more, even though simple, possibility to brace the fuel cell stack 70 has to be provided on the opposing side of the fuel cell stack 70.

In contrast to the bracing plate shown in FIG. 1 a buckling or deformation of the fuel cell stack 70 can be prevented with the bracing plate 10 shown in FIG. 2 not only at room temperature but also at the operating temperature of the fuel cell stack 70. This is enabled by the use of ceramic materials for bracing the fuel cell stack 70 which show no loss of resiliency even when heated up and of the laminated ceramic spring 80 as an elastic element.

FIG. 3 shows a schematic representation of the bracing plate 10 illustrated in FIG. 1 in the fixedly mounted state. There is no longer any gap present between the first layer 20 and the fuel cell stack 70, and the bracing force applied by the bracing screws 50 is transmitted as a uniform pressure. Further an upper part of the fuel cell stack 70 is shown, the individual fuel cells being indicated by parallel lines inside of the stack. The parallel lines are, in this case, simultaneously layers of the different materials of which the individual cells are formed.

The features of the invention disclosed in the above description, in the drawings as well as in the claims may be important for the realisation of the invention individually as well as in any combination.

### LIST OF NUMERALS

10 bracing plate
20 first layer
30 third layer
40 second layer
50 bracing screws
60 draw bars
70 fuel cell stack
80 laminated ceramic spring
90 shutter piece
100 cavity
110 bracing screws

1. A bracing plate for bracing a fuel cell stack, characterised in that
the bracing plate is formed of a plurality of layers,
a first layer facing the fuel cell stack and a second layer disposed adjacent to the first layer and arranged on the side opposing the fuel cell stack are provided, and
the second layer has a higher bending rigidity than the first layer.

2. The bracing plate of claim 1, characterised in that the first layer and the second layer are fixedly connected to each other.

3. The bracing plate of claim 1, characterised in that the second layer comprises a refractory ceramic material.

4. The bracing plate of claim 1, characterised in that the first layer comprises a thin sheet metal.

5. The bracing plate of claim 1, characterised in that a third layer disposed on the side opposing the fuel cell stack is arranged on the bracing plate.

6. The bracing plate of claim 1, characterised in that the third layer comprises a thin sheet metal.

7. The bracing plate of claim 1, characterised in that the second layer and the third layer are fixedly connected to each other.

8. The bracing plate of claim 1, characterised in that means for bracing the fuel cell stack are disposed in the area of the second layer.

9. The bracing plate of claim 8, characterised in that the means for bracing comprise at least one laminated ceramic spring and at least one ceramic draw bar.

10. A device for bracing a fuel cell stack comprising at least one bracing plate of claim 1, characterised in that
the at least one bracing plate is formed of a plurality of layers,
a first layer facing the fuel cell stack and a second layer disposed adjacent to the first layer and arranged on the side opposing the fuel cell stack are provided, and
the second layer has a higher bending rigidity than the first layer.
